(19) United States
(12) Patent Application Publication
(10) Pub. No.: US 2025/0061375 A1
(43) Pub. Date: Feb. 20, 2025

(54) SYSTEMS AND METHODS FOR CONFIGURING TEST PARAMETERS IN MACHINE LEARNING EVALUATION

(71) Applicant: WOVEN BY TOYOTA, INC., Tokyo (JP)

(72) Inventors: Daisuke HASHIMOTO, Tokyo (JP); Eiji Nakatsugawa, Tokyo (JP); Suigen Koide, Kyoto-shi (JP)

(73) Assignee: WOVEN BY TOYOTA, INC., Tokyo (JP)

(21) Appl. No.: 18/450,486

(22) Filed: Aug. 16, 2023

(51) Int. Cl. G06N 20/00

(52) U.S. Cl. CPC G06N 20/00

(57) ABSTRACT

Provided are a method, system, and device for configuring test parameters used in evaluating a machine learning (ML) model. The method may include: obtaining a user input comprising at least one test parameter; storing the obtained user input in a requirement as code (RAC) file; interpreting, by a requirement management interface, at least one test parameter from the RAC file; and evaluating the ML model based on the interpreted at least one test parameter from the RAC file.

### TECHNICAL FIELD

Systems and methods consistent with example embodiments of the present disclosure relate to configuring test parameters for machine learning evaluation.

### BACKGROUND

Machine learning (ML) models may be used to automate a variety of tasks. When developing an ML model, the developer may have certain criteria or parameters which need to be fulfilled by the ML model. For example, if the ML model intends to automate a safety-critical task, the ML model may need to achieve a certain reliability rating. Thus, in order to ensure that the ML model can meet the specifications, it may be necessary for the developer to test and evaluate the ML model by means of performing ML evaluation.

In the related art, simple metrics can be used to automatically determine whether the model is good or not. For example, a Mean Average Precision (mAP) may be used as a simple number to indicate whether or not the ML model is good, bad, or superior.

The degree of evaluation of ML models which can be achieved by related art systems and methods can be limiting and not match the exact criteria or parameters which need to be fulfilled by the ML model. In particular, since only simple metrics can typically be used in the related art, it may be difficult to optimize the ML model's performance, since trying to improve one metric may cause a trade-off/detriment to other metrics. Related art methods systems and methods may not have a means of establishing quantitative and clear criteria for determining which ML model is optimal, particularly in scenarios were there are many candidate ML models.

Further, even if a “good” ML model which passes acceptance testing and has good metric models is found, it is still possible for such a ML model to be considered as suboptimal, there may be unexpected defects in the ML model which would only be found after the ML model is deployed.

Accordingly, there is a need for an improved method for configuring how to perform the ML evaluation process, in particular with respect to the test parameters (which may include requirements, pass criteria, test conditions, etc.)

### SUMMARY

According to one or more example embodiments, apparatuses and methods are provided for obtaining test parameters (which may include requirements, pass criteria, test conditions, etc.) from a user, saving such test parameters into a requirement as code (RAC) file, and interpreting the test parameters from the RAC file using an interface (such as a requirement management interface). Accordingly, the user may easily configure an RAC file to match the requirements needed to meet one standard, and such RAC files can be used independently, in sequence, or in parallel of each other when running an ML evaluation process. Thus, the ML evaluation can be performed to confirm, with a high degree of accuracy, that the ML model being evaluated is optimal with respect to the desired attributes of the ML model.

According to an embodiment, the method may include obtaining a user input comprising at least one test parameter; storing the obtained user input in a requirement as code (RAC) file; interpreting, by a requirement management interface, at least one test parameter from the RAC file; and evaluating the ML model based on the interpreted at least one test parameter from the RAC file.

According to an embodiment, the at least one test parameter may include one or more of an acceptance requirement, an acceptance criteria, or a test condition. The user input may be obtained via a graphical user interface. Obtaining the user input may further include selecting the at least one test parameter from a predefined library of test parameters.

According to an embodiment, evaluating the ML model may be performed by an evaluation interface comprising an inference component and a unit test component. The inference component may be configured to evaluate the ML model by receiving test data and performing an inference process based on the received test data to obtain an output from the ML model, and the unit test component may be configured to evaluate the ML model based on the output from the ML model to obtain metrics.

The output from the ML model may include an inference log, and upon completing the inference process, the inference component may be configured to transfer the inference log to the unit test component, wherein evaluating the ML model comprises evaluating metrics from the inference log, wherein the evaluated metrics are displayed in a graphical user interface.

The method may further include receiving, by the requirements management interface, an instruction to add or update at least one test parameter in the storage layer, wherein the instruction is transmitted from the evaluation interface based on the evaluated metrics and upon completion of evaluating the ML model.

According to an embodiment, an apparatus for configuring test parameterse used in evaluating a machine learning (ML) model may be provided. The apparatus may include: at least one memory storing computer-executable instructions; and at least one processor configured to execute the computer-executable instructions to: obtain a user input comprising at least one test parameter; store the obtained user input in a requirement as code (RAC) file; interpret, by a requirement management interface, at least one test parameter from the RAC file; and evaluate the ML model based on the interpreted at least one test parameter from the RAC file.

According to an embodiment, the at least one processor may be further configured to execute the computer-executable instructions to obtain the user input by selecting the at least one test parameter from a predefined library of test parameters.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a system architecture diagram according to one or more example embodiments; and

FIG. 3 is a flowchart diagram showing a method for configuring an RAC file containing test parameters, and evaluating a ML model based on interpreted test parameters according to one or more example embodiments.

FIG. 4 is a flowchart diagram showing a method for evaluating a ML model according to one or more example embodiments; and

FIG. 5 is a flowchart diagram showing a method for evaluating a ML model including adding or updating requirements according to one or more example embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

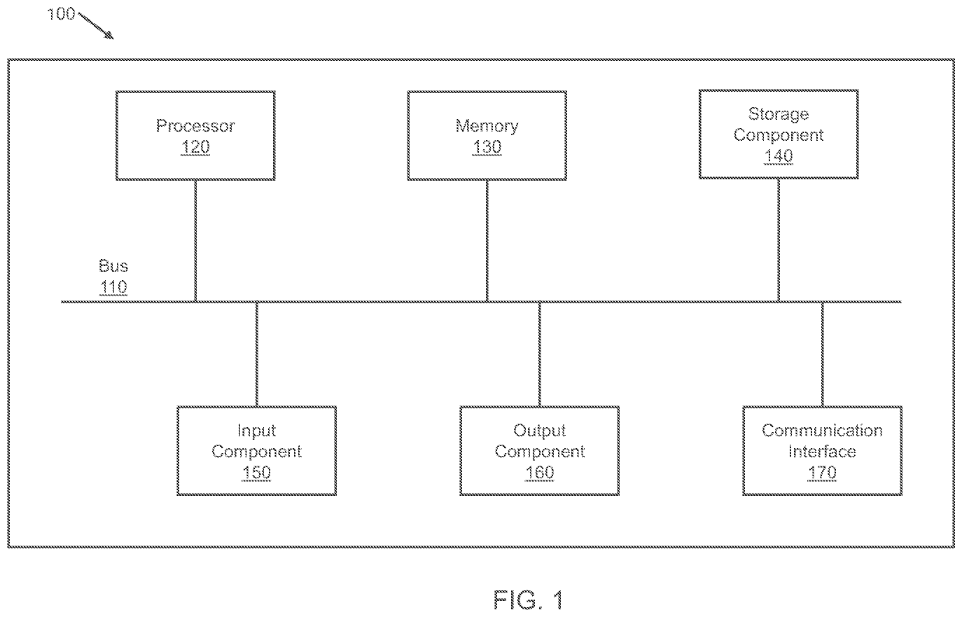

FIG. 1 is a diagram of example components of a machine learning (ML) evaluation device 100. As shown in FIG. 1, ML evaluation device 100 may include a bus 110, a processor 120, a memory 130, a storage component 140, an input component 150, an output component 160, and a communication interface 170.

Bus 110 includes a component that permits communication among the components of ML evaluation device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 220.

Storage component 140 stores information and/or software related to the operation and use of ML evaluation device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits ML evaluation device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from ML evaluation device 100 (e.g., a display, a speaker, and/or one or more light-emitting diodes (LEDs)).

The communication interface 170 includes a transceiver-like component (e.g., a transceiver and/or a separate receiver and transmitter) that enables ML evaluation device 100 to communicate with other devices, such as via a wired connection, a wireless connection, or a combination of wired and wireless connections. The communication interface 170 may permit the ML evaluation device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The ML evaluation device 100 may perform one or more example processes described herein. According to one or more example embodiments, the ML evaluation device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the ML evaluation device 100 may include additional components, fewer components, different components, or differently arranged components than those shown in FIG. 1. Additionally, or alternatively, a set of components (e.g., one or more components) of the ML evaluation device 100 may perform one or more functions described as being performed by another set of components of the ML evaluation device 100.

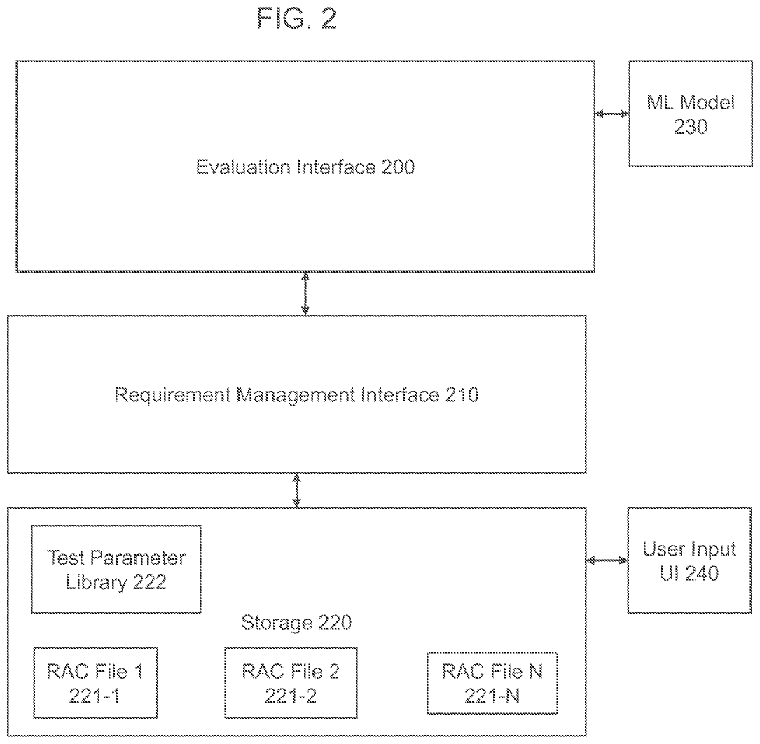

FIG. 2 is a system architecture diagram according to one or more example embodiments.

According to embodiments, evaluation interface 200 may be provided. Evaluation interface 200 may be responsible for executing the ML evaluation process on ML model 230 (e.g., inference and unit testing). It should be appreciated that evaluation interface 200 may implement any appropriate means for executing ML evaluation. Evaluation interface 200 may be configured to receive instructions from requirement management interface 210. It should be appreciated that according to some embodiments, evaluation interface 200 may include a UI (not pictured) in order to output the result of the evaluation to the user. In particular, evaluation interface 200 may transmit an output signal upon completing the evaluation containing the results of the evaluation, and the UI may receive the output signal to display the results of the evaluation. The UI may have a tabular format to list the results of the evaluation test, and it may highlight specific portions of the test results based on whether it passed or failed. Nevertheless, it should be appreciated that whether or not a UI for the evaluation interface 200 is included may depend on the specific implementation, and the configuration thereof may also be determined by a person skilled in the art.

Requirements management interface 210 may be provided. Requirements management layer 210 may be responsible for interpreting the files stored in the storage layer (such as Requirements as Code (RAC) files 1, 2 . . . N (221-1, 221-2, 221-N . . . )). Based on the interpretation of the RAC files, requirement management layer 210 may send instructions to evaluation interface 200 to execute the ML evaluation.

Storage 220 may contain all the data which is used by evaluation interface 200 and requirement management interface 210. Storage 220 may be implemented by any appropriate storage means (e.g., a database, cloud storage, etc.). Storage 220 may contain any number of RAC files 221-1, 221-2, 221-N, and also test parameter library 222. It should be appreciated that each RAC file and test parameter library may be stored in the same storage medium, or different storage mediums.

Requirements as Code (RAC) files 221-1, 221-2, 221-N may be responsible for storing expected behaviors of ML model 230. The expected behaviors may comprise the test parameters. In particular, test parameters may specify what the performance metrics of the ML model 230 which need to be tested, for example, based on a specific metric number which needs to be achieved, a standard which needs to be achieved, a type of test, etc. The RAC files may accordingly include, as test parameters, test targets, file paths of test data, requirements, pass criteria, test conditions, acceptance requirements, acceptance criteria, which are to be used during the ML evaluation process in evaluation interface 200. Accordingly, such requirements, test targets, file paths of test data, pass criteria, and test conditions may be readily interpreted by requirement management interface 210 in order to determine how the ML testing and evaluation of ML model 230 should be executed by evaluation interface 200. For example, the RAC file may contain a criteria in the form of code, and the requirement management interface 210 may interpret the code into an instruction for how to execute the ML evaluation of ML model 230 using evaluation interface 200.

The RAC files may be computer readable code, which is in a format that is easily interpreted by humans. For example, such as YAML format or a Domain Specific Language (DSL) format. This may allow for a person who may not be familiar with coding syntax to readily configure the ML evaluation, or verify that the RAC file matches the quantitative requirements. Furthermore, this may allow for a high degree of customization for example, the end user may adapt the ML evaluation in a more proprietary environment. Further still, since the RAC file is separate from the code which is used to actually run the ML evaluation, it may obviate the need to “hard code” the requirements into the ML evaluation process.

According to an embodiment, the test parameters stored in the RAC file may be related to each other. For example, certain parameters can be related to a specific object and belong to the same group. Alternatively, certain parameters can be in a hierarchical relationship, for example, wherein one criteria is defined by the combination of a result of several other criteria. Nevertheless, the test parameters may also be independent of each other.

Since the overall requirements are in the form of code rather than a set of values, there is a higher degree of accuracy which can be achieved in terms of ensuring that the testing requirements match the actual requirements. This may allow for increased accuracy to ensure that the ML model being evaluated is optimal.

It is contemplated that in the case where multiple RAC files 221-1, 221-2, 221-N are used in a ML evaluation, each RAC files 221-1, 221-2, 221-N could be used to check each of a plurality of sets of requirements (either sequentially, or in parallel). In any event, since the RAC files can separate different sets of requirements, it may be simpler, in some embodiments, to check each set separately (one by one).

According to some embodiments, RAC files 221-1, 221-2, 221-N may be editable by a User Input UI 240. In particular, User Input UI 240 may either be a generic command line interface (command terminal) used to edit the source files, or it may be a graphical user interface (GUI) with interactable elements to allow the user to drag and drop or select pre-determined configurations, or pick from a list. Such pre-determined configurations may be obtained from the test parameter library 222 from storage 200, and may be, for example, one or more commonly used test parameter configurations. Nevertheless, it should be appreciated that any appropriate user interface may be implemented for user UI 240.

Test parameter library 222 may contain predetermined test parameters. Test parameter library 222 may be stored separately from the RAC files according to some embodiments. The specific format of the test parameters in test parameter library 222 may be any appropriate format.

It should be appreciated that the UI's discussed above (including user input UI 240) may be implemented in any appropriate environment, for example, in a web interface, or on the local user device only. It should also be appreciated that according to some embodiments, user input UI 240 may be displayed either separately, or simultaneously from another UI.

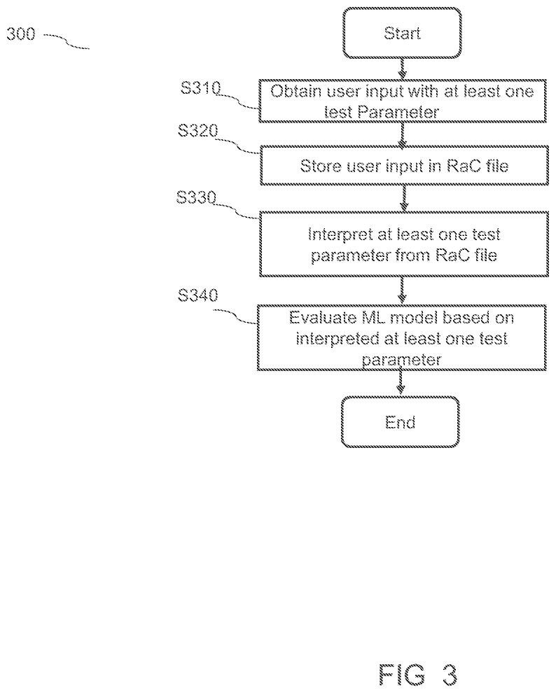

FIG. 3 is a flowchart diagram showing a method 300 for configuring an RAC file containing test parameters, and evaluating a ML model based on interpreted test parameters according to one or more example embodiments.

Referring to FIG. 3, at operation S310, user input containing at least one or more test parameters may be obtained, for example, by using a UI such as user input UI 240 (which may be a GUI or a command line terminal). According to embodiments, the specific format of the user input may be in a human readable format, and one or more test parameters can be input at the same time. Nevertheless, it should be appreciated that the user input may also contain information aside from the one or more test parameters.

At operation S320, the obtained user input from operation S310 may be stored in storage 220 in one or more of RAC files 221-1, 221-2, 221-N. It should be appreciated that depending on the format of the user input, the user input may need to be converted to a different format or data-type prior to being stored in RAC files 221-1, 221-2, or 221-N.

At operation S330, after the test parameters are stored in tn operation S320, the test parameters may be interpreted by requirement management interface 210 in order to determine how to instruct the evaluation interface 200 to perform the ML evaluation on ML model 230. This may include interpreting the requirements, pass criteria, test conditions, acceptance requirement, acceptance criteria, test targets, test data path, model tuning parameters such as confidence thresholds, etc. from the test parameters, and determining the appropriate tests and testing parameters that should be done using evaluation interface 200. Accordingly, interpreted testing parameters may be obtained by requirement management interface 210

At operation S340, evaluation interface 200 may perform the ML evaluation on ML model 230 based on the interpreted testing parameters. For example, the requirement management interface 210 may transmits instructions, based on the interpreted testing parameters from operation S330 to evaluation interface 200 in order to have the evaluation layer 200 perform the ML evaluation on ML model 230. According to some embodiments, once evaluation layer 200 is done performing the ML evaluation, it may transmit an output signal containing the results of the evaluation. According to some embodiments, this output signal may be sent to a UI to display the results.

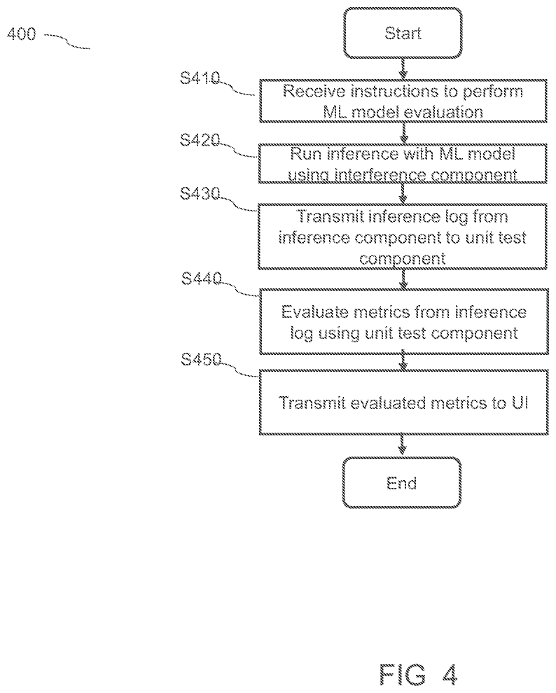

FIG. 4 is a flowchart diagram showing a method 400 for evaluating a ML model using evaluation interface 200 according to one or more example embodiments. The similar layers and components illustrated in FIG. 2 may be used to implement method 400, and the full description of similar steps from method 300 as illustrated in FIG. 3 may be omitted for readability.

According to the embodiment illustrated in FIG. 4, evaluation interface 200 may be provided with an inference component and a unit test component. The inference component may be responsible for receiving test data and inputting the data into ML model 230 to calculate an output using ML model 230 (i.e., inference). The unit test component may be responsible for performing a unit test on ML model 230. Specifically, the unit test may evaluate the result of the output from the ML model 230 obtained during the inference process performed using the inference component on ML model 230. Metrics about the performance of the ML model 230 may be obtained using the unit test component.

Referring to FIG. 4, at operation S410, instructions to perform an ML evaluation may be transmitted from requirement management interface 210, and received by evaluation interface 200 in order to have the evaluation interface 200 perform the ML evaluation on ML model 230. The instruction received in operation S410 may be similar to the one sent in operation S340 as described in FIG. 3 above.

At operation S420, evaluation interface 200 may send an instruction to an inference component to run an inference operation using ML model 230, with test data. The output of this operation may include an inference log, which may include data from running an inference operation on ML model 230 using the test data.

At operation S430, evaluation interface 200 may transmit the inference log from the inference component, to a unit test component.

At operation S440, evaluation interface 200 may send an instruction to the unit test component to evaluate the metrics (e.g., by calculating and comparing the metrics with test criteria from the test parameters).

At operation S450, evaluation interface 200 may output the evaluated metrics (which may include the comparison results). According to some embodiments, this may include transmitting the metrics and comparison results to a UI, such as a GUI.

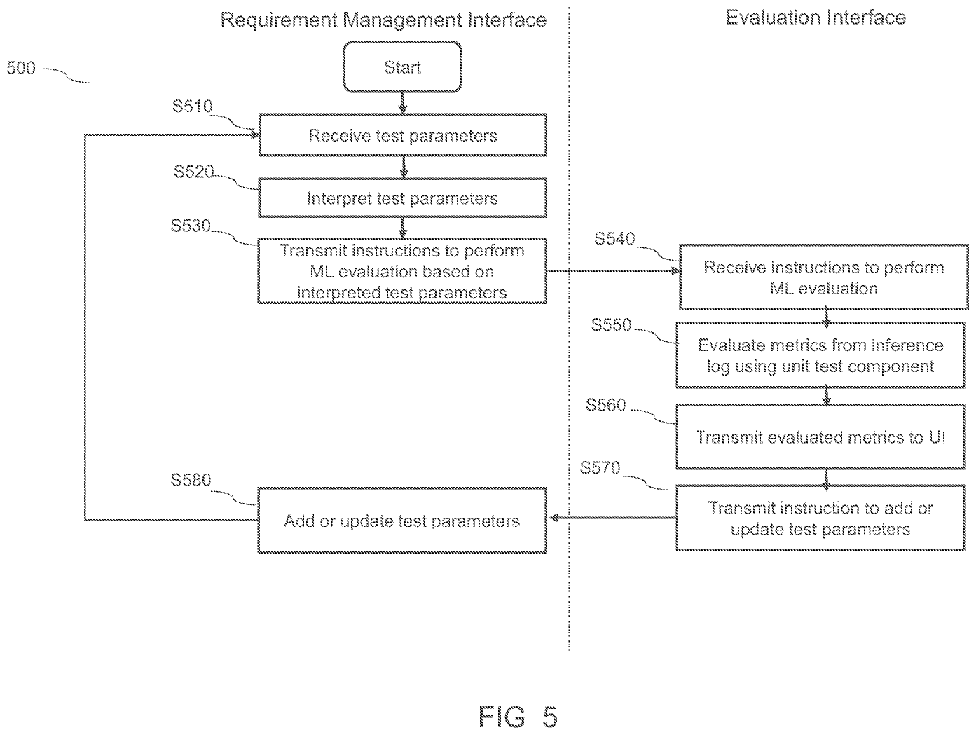

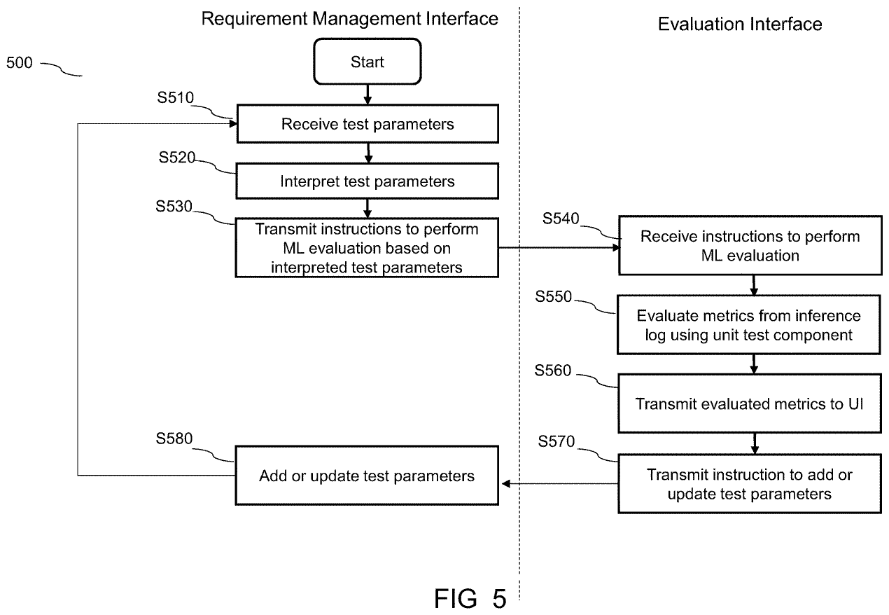

FIG. 5 is a flowchart diagram showing a method for evaluating a ML model including adding or updating requirements according to one or more example embodiments. The similar layers and components illustrated in FIG. 2 may be used to implement method 500, and the full description of similar steps from method 300 as illustrated in FIG. 3 and method 400 as illustrated in FIG. 4 above may be omitted for readability

Referring to FIG. 5, at operation S510, test parameters are received by requirement management interface 210 from storage 220.

At operation S520, after receiving the requirements from storage 220, the requirements may be interpreted by requirement management interface 210 in order to determine how to instruct the evaluation interface 200 to perform the ML evaluation on ML model 230. This may be similar to operation S330 described in FIG. 3 above.

At operation S530, the requirement management interface 210 transmits instructions, based on the interpreted testing parameters from operation S520 to evaluation layer 200 in order to have the evaluation layer 200 perform the ML evaluation on ML model 240. This may be similar to operation S330 described in FIG. 3 above.

At operation S540, instructions to perform an ML evaluation may be received by evaluation interface 200 in order to have the evaluation interface 200 perform the ML evaluation on ML model 230. This may be similar to operation S410 described in FIG. 4 above.

At operation S550, evaluation interface 200 may send an instruction to a unit test component to evaluate metrics (e.g., by calculating and comparing the metrics with test criteria from the test parameters). This may be similar to operation S440 described in FIG. 4 above. It should be appreciated that although not explicitly illustrated, according to some embodiments, operations similar to S420-S430 may also be included prior to operation S550.

At operation S560, evaluation interface 200 may output the evaluated metrics (which may include the comparison results) and transmitting the metrics and comparison results to a UI. This may be similar to operation S450 described in FIG. 4 above.

At operation S570 evaluation interface 200 may transmit an instruction to requirement management interface 210, to add test parameters to storage layer 200 (for example, by adding a new RAC file to storage 220), or to update existing requirements (for example, by editing an existing RAC file in storage 220). The instruction may be transmitted in order to update ML model tuning parameters, such as, but not limited to, confidence thresholds and test parameters for optimizing overall performance of the system, including ML Model 230.

At operation S580, requirement management interface 210 receives the instructions transmitted in operation S570, and adds or updates the requirements in storage 220 accordingly. Thereafter, the steps may be repeated from S510. According to this embodiment, an iterative process for exploring requirements and parameters which may have not yet been discovered may be implemented.

Based on the above embodiments, requirements for test parameters may be defined in a requirement as code (RAC) file, and thus allow for a more complex yet accurate range of test parameters which can be configured for evaluation the machine learning (ML) model. Accordingly, the ML evaluation can be performed to confirm, with a high degree of accuracy, that the ML model being evaluated is optimal with respect to the desired attributes of the ML model.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. A method for configuring test parameters used in evaluating a machine learning (ML) model, the method comprising:
obtaining a user input comprising at least one test parameter;
storing the obtained user input in a requirement as code (RAC) file;
interpreting, by a requirement management interface, at least one test parameter from the RAC file; and
evaluating the ML model based on the interpreted at least one test parameter from the RAC file.

2. The method according to claim 1, wherein the at least one test parameter comprises one or more of an acceptance requirement, an acceptance criteria, or a test condition.

3. The method according to claim 1, wherein the user input is obtained via a graphical user interface.

4. The method according to claim 3, wherein obtaining the user input further comprises: selecting the at least one test parameter from a predefined library of test parameters.

5. The method according to claim 1, wherein evaluating the ML model is performed by an evaluation interface comprising an inference component and a unit test component, wherein the inference component is configured to evaluate the ML model by receiving test data and performing an inference process based on the received test data to obtain an output from the ML model, and the unit test component is configured to evaluate the ML model based on the output from the ML model to obtain metrics.

6. The method according to claim 5, wherein the output from the ML model comprises an inference log, and wherein upon completing the inference process, the inference component is configured to transfer the inference log to the unit test component, wherein evaluating the ML model comprises evaluating metrics from the inference log, wherein the evaluated metrics are displayed in a graphical user interface.

7. The method according to claim 6, wherein the method further comprises:
receiving, by the requirements management interface, an instruction to add or update at least one test parameter in the storage layer, wherein the instruction is transmitted from the evaluation interface based on the evaluated metrics and upon completion of evaluating the ML model.

8. An apparatus for configuring test parameterse used in evaluating a machine learning (ML) model, the apparatus comprising:
at least one memory storing computer-executable instructions; and
at least one processor configured to execute the computer-executable instructions to:
obtain a user input comprising at least one test parameter;
store the obtained user input in a requirement as code (RAC) file;
interpret, by a requirement management interface, at least one test parameter from the RAC file; and
evaluate the ML model based on the interpreted at least one test parameter from the RAC file.

9. The apparatus according to claim 8, wherein the at least one test parameter comprises one or more of an acceptance requirement, an acceptance criteria, or a test condition.

10. The apparatus according to claim 8, wherein the user input is obtained via a graphical user interface.

11. The apparatus according to claim 10, wherein the at least one processor is further configured to execute the computer-executable instructions to obtain the user input by selecting the at least one test parameter from a predefined library of test parameters.

12. The apparatus according to claim 8, wherein the at least one processor is further configured to evaluate the ML model using an evaluation interface comprising an inference component and a unit test component, wherein the inference component is configured to evaluate the ML model by receiving test data and performing an inference process based on the received test data to obtain an output from the ML model, and the unit test component is configured to evaluate the ML model based on the output from the ML model to obtain metrics.

13. The apparatus according to claim 12, wherein the output from the ML model comprises an inference log, and wherein upon completing the inference process, the inference component is configured to transfer the inference log to the unit test component, wherein evaluating the ML model comprises evaluating metrics from the inference log, wherein the evaluated metrics are displayed in a graphical user interface.

14. The apparatus according to claim 13, wherein the at least one processor is further configured to:
receive, by the requirements management interface, an instruction to add or update at least one test parameter in the storage layer, wherein the instruction is transmitted from the evaluation interface based on the evaluated metrics and upon completion of evaluating the ML model.

15. A non-transitory computer-readable recording medium having recorded thereon instructions executable by at least one processor to cause the processor to perform a method comprising:
obtaining a user input comprising at least one test parameter;
storing the obtained user input in a requirement as code (RAC) file;
interpreting, by a requirement management interface, at least one test parameter from the RAC file; and
evaluating the ML model based on the interpreted at least one test parameter from the RAC file.

16. The non-transitory computer-readable recording medium according to claim 15, wherein the at least one test parameter comprises one or more of an acceptance requirement, an acceptance criteria, or a test condition.

17. The non-transitory computer-readable recording medium according to claim 15, wherein the user input is obtained via a graphical user interface.

18. The non-transitory computer-readable recording medium according to claim 15, wherein evaluating the ML model is performed by an evaluation interface comprising an inference component and a unit test component, wherein the inference component is configured to evaluate the ML model by receiving test data and performing an inference process based on the received test data to obtain an output from the ML model, and the unit test component is configured to evaluate the ML model based on the output from the ML model to obtain metrics.

19. The non-transitory computer-readable recording medium according to claim 18, wherein the output from the ML model comprises an inference log, and wherein upon completing the inference process, the inference component is configured to transfer the inference log to the unit test component, wherein evaluating the ML model comprises evaluating metrics from the inference log, wherein the evaluated metrics are displayed in a graphical user interface.

20. The non-transitory computer-readable recording medium according to claim 19, wherein the method further comprises:
receiving, by the requirements management interface, an instruction to add or update at least one test parameter in the storage layer, wherein the instruction is transmitted from the evaluation interface based on the evaluated metrics and upon completion of evaluating the ML model.
